(19) United States
(12) Patent Application Publication
(10) Pub. No.: US 2011/0248088 A1
(43) Pub. Date: Oct. 13, 2011

(54) TAG FOR IDENTIFYING AND TRACING A PRODUCT, METHOD FOR MANUFACTURING SUCH A TAG AND PRODUCT COMPRISING SAME

(75) Inventors: Christophe Edouard, Auxon Dessous (FR); Remy Mouillet, Besancon (FR)

(73) Assignees: FLOWDIT, Les Pennes Mirabeau (FR); SARL ATELIER MAURICE, Besancon (FR)

(21) Appl. No.: 12/989,721

(22) PCT Filed: Apr. 20, 2009
(86) PCT No.: PCT/FR2009/050727

§ 371 Date: Dec. 9, 2010

(30) Foreign Application Priority Data
Apr. 30, 2008 (FR) 0852928

(51) Int. Cl. G06K 19/06; G06K 19/00

(52) U.S. Cl. 235/491; 235/487

(57) ABSTRACT

An identification label intended to be associated with a product, characterized in that it is formed by an unforgeable high purity silicon element forming per se a distinctive sign and/or on which micrometric or nanometric identification codes are made, said label being added onto the product or implanted in the latter, so as to ensure its traceability and attest to its origin and to its authenticity.

Tag for identifying and tracing a product, method for manufacturing such a tag and product comprising same

The object of the present invention is an identification label intended to be associated with a product in order to allow it to be traced over time, from its manufacturing.

In order to better apprehend the invention, it is worth recalling the systems known to this day for establishing the traceability of a product.

Bar codes have been precursors in this field. They are printed on packages or on labels of products and contain information on the product strictly speaking, i.e. manufacturing location, date, etc. These codes consist of a succession of bars and spaces which in a structured way represent a chain of characters. There are two types of barcodes: linear barcodes and two-dimensional barcodes.

RFID identical labels are also known in this field.

These RFID (Radio Frequency Identification) labels use radiofrequency signals for transmitting or receiving information. Like barcodes, they provide rapid identification of the product. These labels consist of an electronic chip and of a coiled or printed antenna. The operating principle of RFID labels consists of activating the label by a variable frequency radio signal which the reader emits. The label transmits back a radio signal which the reader transforms into a binary code. A dialog is established allowing the exchange of information. As earlier, there are two types of RFID labels: passive labels and active labels.

RFID labels give excellent results as regards traceability, but are difficult to exploit in the fight against counterfeit because of their size, which is not of still smaller size.

The object of the present invention is specifically to solve the dual problem of recognizing the original products and that of detecting counterfeits, while of course also allowing traceability of the product.

According to a first phase of the inventive approach, the manufacturing of a practically non-reproducible identification label was devised starting from simple and conventional means, but on the contrary requiring manufacturing steps which could not be performed by means other than heavy pieces of equipment and requiring qualified personnel. In this way, it is quasi impossible to set up illicit clandestine workshops, and even to use these pieces of equipment in recognized organizations for illegal purposes.

Thus, the identification label according to the invention is characterized in that it is formed with a high purity silicon element forming per se a distinctive sign and/or on which micrometric or nanometric identification codes are made, said label being added onto the product or implanted in the latter, so as to ensure its traceability and to attest to its origin and its authenticity, while making it non-reproducible.

Silicon has unequalled machining characteristics. The goal is to be able from this material to develop methods for manufacturing labels pertaining to microtechnology, or even nanotechnology.

By wisely selecting this material, against any prejudice, surprising and unexpected results were obtained during the tests.

The structuration of this material by micromanufacturing methods shows a characteristic which is absolutely non-reproducible with other materials, i.e. the recess or the relief on the label at micrometric or nanometric scales having aspect factors (ratio between the largest dimension to the smallest) greater than 5.

As a comparison, a machining milling cutter in micromechanics on any material cannot allow such reamings.

Also as a comparison, the use of power lasers for structuring certain materials is capable of attaining these surface resolutions, but cannot by any means extrude this pattern with form factors greater than about ten, and for thicknesses of several hundred microns. Laser machining only allows surface structuration, i.e. of a few microns in depth, therefore easily erasable, while by wisely selecting silicon, it is possible to integrate information onto the label by deep etching, by ion reaction, of the order of one hundredth of a millimetre.

As mentioned above, such a label according to the invention is practically made unforgeable because of the requirement of heavy means and qualified personnel. More particularly, allusion is made to clean rooms which are practically the only environments in which the aforementioned technique may be performed.

Indeed, only a clean room allows control, minimization of the introduction, generation and retention of particles inside a working volume which may receive manufacturing equipment. The parameters such as temperature, humidity and relative pressure are also maintained at a predetermined level.

Clean rooms are used in fields sensitive to environmental contaminations, i.e. methods for manufacturing semiconductor devices, biotechnologies and other fields of biology, the building of spacecraft, the construction of optical devices or of micromechanisms, etc.

It is thereby well understood that the use of clean rooms is not easily accessible for making an identification label according to the invention.

An identification label made in this way results from the etching of a planar pattern which may be formed by a logo, or quite simply by a silicon bar to be introduced into the product to be identified. An extension in depth is possible with any geometry defined in this plane.

It should be noted that a same label may contain one or more etches according to micrometric specifications. The label may be transferred onto a support forming the actual product by adhesive bonding or insertion methods during the manufacturing of said product.

The identification label may either be visible or not on the support intended to be protected. It may contain an identification code in relief or recessed i.e. hollowed out always with the same method for etching silicon and its dimensional characteristics.

According to another feature of the invention, the identification label includes cavities, such as a container, in which suitable physico-chemical elements are placed, for monitoring equipment, for increasing the contrast between the label and the product to be identified.

The role of these materials is to increase the contrast between the labelled element and the label and/or increase the reading resolution of the monitoring devices when they are subject to an outer excitation of the radiation type.

Other means allowing transfer or inclusion of the label on the product to be protected may be used, such as adhesive bonding, insertion of the mechanical type, moulding, overmoulding, recessed fitting, welding, riveting, encapsulation, on or in the product to be identified.

Other parts may be reproduced from the original silicon part, which may act in turn as identification labels. In this case, the original silicon label would be used as a mould for transferring the pattern (as a negative) onto moulded and/or agglomerated materials in the mould by means of binders, by exposure to ultraviolet rays, to temperature, or other means.

Such embodiments totally or partly resort to photolithographic steps with micrometric resolution, to silicon etching methods with a high form factor and to silicon oxide etching steps.

It is also directly or indirectly resorted to the method for micro-machining silicon by transferring patterns, ensured by moulding from the silicon structure used as an initial mould.

The invention also relates to the method for manufacturing an identification label as it has just been described. According to this method, the silicon identification label is covered with protective means of the resin, varnish, polymer or binder-based agglomerated material type, the melting temperature of which is less than that of silicon.

The adherence properties of said protective resin may be used for transferring the label onto the product to be protected.

As regards the means for protecting the label, the latter is determined depending on the type of material, which may be transparent, translucent or opaque.

Depending on the case of application, the silicon identification label directly receives the protective means on either side of its own faces.

The identification label may be obtained by machining from a silicon substrate, or further by moulding starting from a silicon powder and/or from a structured silicon mould from the same techniques.

The protective means, in this case the resin, may be coloured and/or screen-printed.

According to an alternative embodiment, the label receives a deposit based on nitride or another material with the purpose of imparting to said label a selected colour.

Also the protective layer should itself have great accuracy in reproducing the structured patterns in the silicon. The use for this purpose of a polymer, such as Parylène™, fully meets these characteristics as long as its compliance properties during the deposition has resolutions very close to those of the machining of silicon.

The innovating features of the identification label according to the invention are the following:
it cannot be reshaped in any way after having been detached from its initial substrate, without any consequence of failure or bursting of the material or of the label.
it cannot be reworked, remachined by clean room equipment after having been detached from its original substrate, these pieces of equipment being alone compatible with silicon substrates of standardized size appearing as a disk in the presence of one or several flats. Only these standard sizes are compatible with the loading supports of each of the pieces of equipment used.
it does not require any supply of energy for ensuring the traceability function, since it is inert.
the imprints are revealed by specific reading means. These latter means may range from the simple system (magnifying glass, microscope) to more complex apparatuses. In fact, the identification label reacts to an external excitation means of the magnetic radiation, electrostatic radiation, or X-ray type aiming at revealing it.
it may assume a selected colour, which will be revealed by the thickness of the deposited material, in the case of a silicon nitride deposit, or the actual material, in the case of deposition of a bulk-dyed material of the colouring agent type.
it may contain several elements rigidly or flexibly assembled, machined with the same micromanufacturing method.
it may contain one or more mobile portions, themselves machined with the same micromanufacturing methods.
the property of such a label as regards fighting against counterfeit.

The machining method provides very great freedom in the determination of the patterns to be transferred onto the silicon element. Thus, the reproduction of identification code may be devised in the form of figures, letters, barcodes, abbreviations, or of any possible geometrical shape.

These patterns may appear raised or recessed. This very great flexibility is applied within the scope of the feasibility of micromanufacturing, i.e. with observance of the form factor, a limit accessible via the method. If this limit is exceeded, it is no longer possible to guarantee sufficient accuracy on the verticality of the flanks at the end of the etching.

This manufacturing method requires at least four heavy pieces of equipment in terms of costs, i.e. about 2.5 million Euros.

These pieces of equipment are formed by: an apparatus for manufacturing masks (sub-micron resolution); a resin adhesion promoter; an apparatus for coating/developing resin; an apparatus for insolation of substrates, with precision alignment capability (sub-micron resolution); an apparatus for etching silicon and silicon oxide.

Further, this method requires a certain number of qualified personnel, engineers and specialized technicians, for ensuring application and maintenance of all these apparatuses.

The micromanufacturing of silicon substrates can only be accomplished in a very clean environment, called a clean room. This location involves the installation of specific equipment ensuring permanent circulation of air, a constant cleanliness property and therefore qualified personnel dedicated to its maintenance. This is exactly the strict environment which guarantees proper execution of the manufacturing method.

The introduction of any impurity, whatever it is, which may affect each manufacturing step, proves to be redhibitory for the execution of the method.

These machines cannot be manufactured differently except by the official manufacturer because of the complexity of the matter.

Further, these machines are distributed in a rather limited number worldwide, specifically owing to the cost, causing mutualisation of their use, and the purchasers are perfectly identified, whence the difficulty of using them for counterfeiting purposes.

On the other hand, supply of specific and expensive materials which are the consumables such as resin, gases used for etching, glass and silicon substrates, cannot be traded illegally.

Further, as the cost of the consumables (silicon substrates and glass substrates, used as masks, resin, gas lines) is very expensive, the use of the latter for illicit purposes can only be very rapidly detected by the responsible persons for these pieces of clean room equipment.

Firstly, it may be stated that considering the rarity of the this method and the very great difficulty of its illegal application, since both the required equipment is heavy and very qualified personnel is required, the presence alone of a silicon element of this type convinces of the authenticity of the product.

Moreover, any modification attempt after applying the method and after installing the label on the product systematically causes a visual modification of the aspect of the label. There is only one chemical element capable of attacking silicon in a wet phase.

The latter will thus have the effect of removing material, along crystalline planes, which will be strongly contrasted with the large verticality of the flanks obtained by deep etching of silicon, which is anisotropic etching and is accomplished via a dry route. This transformation is then very easily visible and will thereby confirm malevolent shaping of the label.

Another characteristic of silicon which has been exploited is its low specific gravity with regard to other materials which may be used, such as stainless metals. Indeed, the specific gravity of silicon is very close to that of aluminium, i.e. of the order of 2.3 g/cm³. Now most alloys of stainless metals have specific gravities of the order of 7.8 g/cm³, i.e. about 3.3 times that of silicon.

All in all, for protected products, for which weight is a real constraint, adjunction of a silicon label will allow the traceability function to be ensured with a negligible impact of the final mass of the product. As an example, in the field of culture pearls, by comparison, a solid silicon bar used for marking the nucleus of a pearl, has a mass of the order of 1 mg, while the same made in stainless materials would weigh more than 3 mg. The retained volume in this case is that of a parallelepiped with a length of 3 mm, and a width and height of 380 micrometers.

Other applications are of course possible, such as for example in the automotive sector and in automotive spare parts, aeronautics, aerospace, armament, archaeology, jewels, time-pieces, audiovisual aids, leather goods, pharmacy, cosmetic products, clothes, wines and spirits, toys and artwork objects.

Moreover, all these applications may benefit from integration which is either visible or invisible to the naked eye from insertion of coding allowing identification of the product of counterfeit imitations.

This insertion is impossible to forge since any modification attempt would cause destruction of the silicon pattern.

1. An identification label intended to be associated with a product, wherein the label is formed by a silicon element, being per se a distinctive sign and/or on which micrometric or nanometric identification codes are made, said label being added onto the product or implanted in the product, so as to ensure its traceability and to attest to its origin and to its authenticity, while making it non-reproducible and non-reshapable.

2. The label according to claim 1, wherein the distinctive sign and/or the micrometric identification codes are made on the silicon element by deep etching with ion reaction.

3. The label according to claim 2, wherein the identification codes are in relief.

4. The label according to claim 2, wherein the identification codes are recessed.

5. The label according to claim 1, wherein the label includes cavities, in which are placed physico-chemical elements favourable for monitoring equipment, to the increase of the contrast between the label and the product to be identified.

6. The label according to claim 5, wherein the label is transferred or included on or into the product to be identified.

7. The label according to claim 6, wherein a physico-chemical element reacts to an outer excitation means of the magnetic radiation, electrostatic radiation or X-ray type aiming at revealing it.

8. The label according to claim 1 or 5, wherein the label is revealed by a specific piece of equipment of the magnifying glass, microscope type.

9. The label according to claim 1 or 5, wherein the label is covered with Parylene.

10. The label according to claim 1 or 5, wherein the label consists of several elements.

11. A method for manufacturing an identification label according to claim 1 or 5, wherein the label is covered with a protective means of the resin, varnish, polymer or binder-based agglomerated material type.

12. The method according to claim 11, wherein the thickness of the resin forming the protective means is determined depending on the type of resin, which may be transparent, translucent or opaque.

13. The method according to claim 11, wherein the silicon label directly receives the protective resin on either side of its own faces.

14. The method according to claim 11, wherein the label is obtained by machining from a silicon substrate.

15. The method according to claim 11, wherein the label is obtained by moulding, from silicon powder and/or a silicon mould structured from the same techniques.

16-18. (canceled)

19. An identification label for a product comprising:
a silicon element having micrometric or nanometric identification codes formed from physico-chemical agents, said agents being excitable by radiation to reveal said identification codes.
